(19) United States
(12) Patent Application Publication
(10) Pub. No.: US 2006/0173735 A1
(43) Pub. Date: Aug. 3, 2006

(54) Targeted mailing services

(76) Inventors: George M. Brookner, Norwalk, CT (US); Dennis Gilham, Essex (GB)

Correspondence Address: PERMAN & GREEN, 425 POST ROAD, FAIRFIELD, CT, 06824, US

(21) Appl. No.: 11/047,394

(22) Filed: Jan. 31, 2005

(51) Int. Cl. G06Q 30/00

(52) U.S. Cl. 705/14

(57) ABSTRACT

A method for providing mailing services targeted to a particular market sector includes securely identifying a demographic segment of a population for special attention, and providing a security means to authenticate a user of a targeted demographic population segment.

### BACKGROUND OF THE INVENTION

The present invention is related to the provision of mailing services targeted to a particular market sector.

### BRIEF DESCRIPTION OF RELATED DEVELOPMENTS

Businesses and particularly the Post provide services to their customers that require an infrastructure and resources of a defined magnitude to support the business activities necessary to sustain their customer base. This leads to an ongoing and iterative problem with attempting to keep the work flow and work effort at a marginal level so as to not overload the system, nor have excessive under utilized capacity. Typically, both the overload and under capacity scenarios are commonplace.

### SUMMARY OF THE EXEMPLARY EMBODIMENTS

The exemplary embodiments are directed to providing mailing services targeted to a particular market sector by securely identifying a demographic segment of a population for special attention, and providing a security means to authenticate a user of a targeted demographic population segment.

### BRIEF DESCRIPTION OF THE DRAWINGS

The foregoing aspects and other features of the present invention are explained in the following description, taken in connection with the accompanying drawings, wherein:

FIG. 1 shows a general diagram of a typical system architecture.

### DETAILED DESCRIPTION OF THE EXEMPLARY EMBODIMENTS

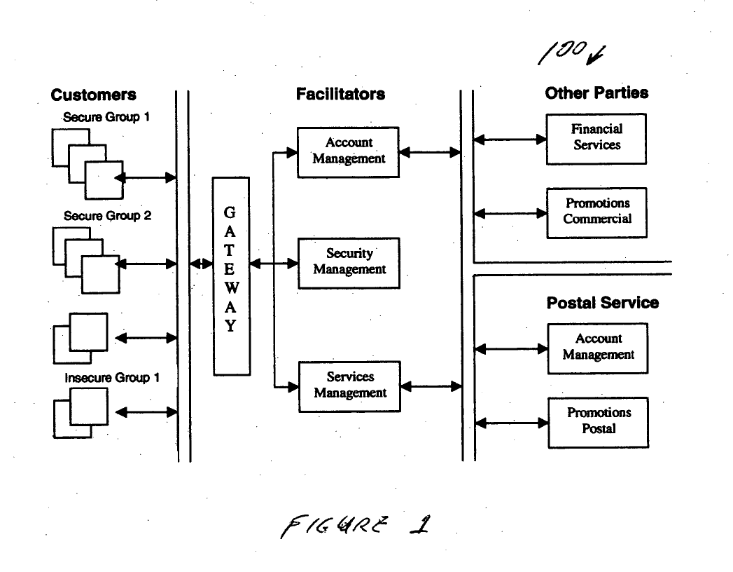

FIG. 1 shows a block diagram of a system suitable for practicing the embodiments disclosed herein. Although the exemplary embodiments will be described with reference to the embodiment shown in the drawings, it should be understood that the present invention can be embodied in many alternate forms of embodiments. In addition, any suitable size, shape or type of elements or materials could be used.

The disclosed embodiments provide a method and secure system process to allow users of said method and system to be able to target, from a demographic base, incentives to attract said demographic base to provide input to the under utilized system when most beneficial to the operator of said system, and to refrain from providing input to an overloaded system when so desired by the operator of said overloaded system.

The embodiments disclosed herein are directed to providing service offers having financial benefits to customers. For example, introductory offers on new services may be provided during a specified period of time, special offers on existing services may be offered during a specified period of time, and introductory offers for new users may be supplied for a specified period of time.

Other offers might includes discounts for bulk mailings, that meet qualifying conditions, according to date of deposit and geographical locations, discount offers for incremental volumes over a previous period and for a limited period of time, and offers to specific targeted market sectors, e.g. financial sector, for a specified period of time.

It is a feature of the disclosed embodiments to provide the capability of securely identifying a demographic segment of the population for special attention.

It is another feature of the disclosed embodiments to provide security means to authenticate the user of a targeted demographic population segment.

Some controls over the process may include basing offers on certain characteristics such as the date/time, services, running counts on reserved and deposited items of mail, customer batch sizes, machineable mail or other format definition, e.g. flats, user start date (new licenses), user totals, e.g. volumes/postage, customer business service classifications codes, geographical locations for mail generation sites, CASS certifications and other distinguishing requirements, etc.

Other controls over the process may include basing offers on certain security characteristics (Authentications/Validations) such as Customer, Offer promoter (USPS/Other), Mail piece/batch, Postage, Transaction, Account details, Open/Closed systems, etc.

Certain aspects of the process may be automated, for example, Customer identification, Characteristic Selection Possibilities, e.g. via USPS automated processes, i.e. virtual selections according to predefined conditions or with optional authorization, Security, Transactions, Communications, Dynamic offer adjustments according to offer usage/take-up, etc.

Operational aspects may include Customer Selections, Tag offer to user process/job, GUI features e.g. click & drag, Promotion Offer Characteristic Selection, Polling Qualified Customers—Offer Notification, Reservations/Pre-announcements Time Limited, Final Announcements plus file transfer for deposited mailings, e.g. SOM, Payments/Transactions—Pre & Post-payment management, Statements/Reports, History of Events/Analysis of Usage, Links to other systems/servers/Internet sites, etc.

Communications aspects may include Direct access for offer promotions with authentication, Access via third parties, e.g. service consolidators and third parties acting as sub-promotions providers, Secure communications channel, Authentication, Processing/Database security, e.g. FIPS Compliant, etc.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method for providing mailing services targeted to a particular market sector comprising:
securely identifying a demographic segment of a population for special attention; and
providing a security means to authenticate a user of a targeted demographic population segment.

2. The method of claim 1 further comprising providing service offers having financial benefits to customers.

3. The method of claim 2, wherein the service offers are provided during a specified period of time.

4. The method of claim 2, wherein the service offers are based on at least information pertaining to mail piece characteristics and/or mail piece volumes.

5. The method of claim 2, wherein the service offers are based on at least information pertaining to the customers.

6. The method of claim 2, wherein the service offers are based on at least authentication/validations pertaining to the customers or a promoter.

7. The method of claim 2, wherein the service offers are based on at least authentication/validations pertaining to mail piece characteristics.

8. An apparatus for providing mailing services targeted to a particular market sector comprising:
a means for identifying a demographic segment of a population for special attention; and
a security means to authenticate a user of a targeted demographic population segment.

9. The apparatus of claim 8 further comprising a means for providing service offers having financial benefits to customers.

10. The apparatus of claim 9, wherein the service offers are provided during a specified period of time.

11. The apparatus of claim 9, wherein the service offers are based on at least information pertaining to mail piece characteristics and/or mail piece volumes.

12. The apparatus of claim 9, wherein the service offers are based on at least information pertaining to the customers.

13. The apparatus of claim 9, wherein the service offers are based on at least authentication/validations pertaining to the customers or a promoter.

14. The apparatus of claim 9, wherein the service offers are based on at least authentication/validations pertaining to mail piece characteristics.
